(19) United States
(12) Patent Application Publication
(10) Pub. No.: US 2010/0070293 A1
(43) Pub. Date: Mar. 18, 2010

(54) SYSTEMS AND METHODS FOR DETERMINING A COURSE OF ACTION IN A REAL-TIME CASE BASED ON ANALYSIS OF TREND DATA IN HISTORICAL CASES

(75) Inventors: Christopher J. Brown, North Ferrisburg, VT (US); Jessica Bolduc, South Burlington, VT (US); Forrest Chamberlain, South Burlington, VT (US); Sriram Peri, South Burlington, VT (US)

Correspondence Address: MCANDREWS HELD & MALLOY, LTD, 500 WEST MADISON STREET, SUITE 3400, CHICAGO, IL, 60661, US

(73) Assignee: General Electric Company, Schenectady, NY (US)

(21) Appl. No.: 12/209,359

(22) Filed: Sep. 12, 2008

(51) Int. Cl. G06Q 50/00

(52) U.S. Cl. 705/2; 705/1

(57) ABSTRACT

Systems and methods for determining a course of action in a real-time case based on analysis of trend data in historical cases. The system includes an historical initial data interface; an historical outcome interface; an historical response interface; an historical database; a trend analyzer; and a trend analysis interface. The method includes obtaining historical initial data for more than one historical case; associating an historical response and an historical outcome with each of the historical cases; storing the historical initial data and the associated historical responses and outcomes for each of the historical cases; identifying trends between the historical initial data and the associated historical responses and outcomes in the historical cases; obtaining initial data for the real-time case; and determining a course of action in the real-time case based on the identified trends from historical cases having similar historical initial data to the initial data in the real-time case.

### RELATED APPLICATIONS

Not Applicable

### FEDERALLY SPONSORED RESEARCH OR DEVELOPMENT

Not Applicable

### MICROFICHE/COPYRIGHT REFERENCE

Not Applicable

### BACKGROUND OF THE INVENTION

Generally, the technical field involves systems and methods for determining a course of action in a real-time case based on analysis of trend data in historical cases. Specifically, the technical field involves clinical systems and methods for determining treatment and/or priority of diagnosis in a real-time case based on analysis of outcome trends in historical data.

In many fields, an individual analyzes data prior to determining a course of action. The individual then determines the proper course of action based on that analysis. Oftentimes, the individual is forced to consider large amounts of data under harsh time constraints. These time factors can make it difficult to accurately analyze the data and reach an accurate determination.

Current systems and methods rely on a person to properly identify situations requiring immediate assistance and to determine the proper course of action. The use of a manual step in identifying risky situations and determining the proper course of action allows for human error. This is particularly true where the individual making the decision has to analyze large amounts of data under harsh time constraints.

In a clinical setting, a clinician analyzes a patient's signs, symptoms, test results, medical history and other defining attributes, such as gender, age, weight, race, level of physical fitness, etc. The clinician then makes a diagnosis and determines a course of treatment based on that analysis. The clinician considers large amounts of data under harsh time constraints. Failure to identify a risky situation, make a quick diagnosis and/or quickly identify a course of treatment can cause valuable time to be lost. Lost time could potentially affect the clinical outcome negatively, resulting in injury or even death of the patient.

Current systems and methods rely on the clinician, often the referring physician, to properly identify patients requiring immediate assistance and to determine the proper diagnosis and/or treatment for those patients. The use of a manual step in identifying risky situations and determining the diagnosis and/or treatment, allows for human error. This is particularly true in a clinical setting, where the individual making the analysis is required to analyze large amounts of data under harsh time constraints.

### BRIEF SUMMARY OF THE INVENTION

Certain embodiments of the present technology provide systems and methods for determining a course of action in a real-time case based on analysis of trend data in historical cases.

Certain embodiments of the present clinical system for determining a course of action in a real-time patient case based on analysis of trend data in historical patient cases include an historical initial data interface wherein the historical initial data interface allows for input of historical initial data regarding more than one historical case; an historical outcome interface wherein the historical outcome interface allows for association of an historical outcome with each of the historical cases; an historical response interface wherein the historical response interface allows for association of an historical response with each of the historical cases; an historical database wherein the historical database stores the historical initial data and the associated historical responses and outcomes of each of the historical cases; a trend analyzer wherein the trend analyzer identifies trends between the historical initial data and the historical responses and outcomes; and a trend analysis interface wherein the trend analysis interface allows for input of initial data regarding the real-time case and wherein the trend analysis interface displays output regarding a recommended course of action in the real-time case based on the identified trends from historical cases having similar initial data to the initial data regarding the real-time case.

Certain embodiments of the present clinical method for determining a course of action in a real-time patient case based on analysis of trend data in historical patient cases include obtaining historical initial data for more than one historical case; associating an historical response with each of the historical cases; associating an historical outcome with each of the historical cases; storing the historical initial data and the associated historical responses outcomes for each of the historical cases; identifying trends between the historical initial data and the associated historical responses and outcomes in the historical cases; obtaining initial data for the real-time case; and determining a course of action in the real-time case based on the identified trends from historical cases having similar historical initial data to the initial data in the real-time case.

Certain embodiments of the present computer-readable medium having a set of instructions for execution by a computer include an historical initial data collection routine configured to collect historical initial data for more than one historical case; an historical response association routine configured to associate an historical response with each of the historical cases; an historical outcome association routine configured to associate an historical outcome with each of the historical cases; a storage routine configured to store the historical initial data and the associated historical responses and outcomes for each of the historical cases; a trend identification routine configured to identify trends between the historical initial data and the associated historical responses and outcomes in the historical cases; a real-time data collection routine configured to collect initial data for a real-time case; and a display routine configured to display a determined course of action for the real-time case based on the identified trends from historical cases having similar historical initial data to the initial data in the real-time case.

These and other features of the present invention are discussed or apparent in the following detailed description.

### BRIEF DESCRIPTION OF SEVERAL VIEWS OF THE DRAWINGS

FIG. 1 illustrates a clinical system for determining a course of action in a real-time patient case based on analysis of trend data in historical patient cases according to an embodiment of the present technology.

FIG. 2 illustrates a flow diagram for a clinical method of determining a course of action in a real-time patient case based on analysis of trend data in historical patient cases according to an embodiment of the present technology.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

The current technology relates to clinical systems and methods for determining a course of action in a real-time patient case based on analysis of trend data in historical patient cases.

Historical data that is stored in information systems represents a resource that can be used to help individuals make better decisions based on trend analysis. If a certain course of action created good results in the large number of similar situations, an individual may want to follow the same course of action. Trend analysis could also be used to alert a user of a dangerous situation where certain factors have indicated a dangerous situation in a large number of similar situations.

In a clinical setting, historical data for patients that is stored in medical information systems represents a resource that could be used to help clinicians make better decisions at the point of care. This resource remains largely untapped. These systems and methods propose to analyze historical data to provide suggestions to clinicians based on that analysis.

In a clinical setting, the current systems and methods use patient data anonymously to provide prioritization of diagnosis and/or recommend options for treatment. This is done by matching relevant factors from the current patient's information with similar relevant factors of aggregate historical patients' data. The current systems and methods prioritize diagnosis and/or recommend predictive treatments based on aggregating anonymous data that was previously entered into a healthcare information system.

The current clinical systems and methods give users additional, evidence-based guidance when prioritizing diagnosis and recommending treatments. The current systems and methods will analyze trends in historically captured data to provide information that can help in successful treatment of current patients.

In one embodiment, the current methods and systems provide automation to help recognize trends that indicate an imminent problem. This allows a user to ensure that a course of action is determined in a timely manner based on trend analysis. In a clinical setting, methods and systems of this embodiment provide automation to help ensure that timely treatment is provided to high-risk patients who require such treatment.

The value in prioritizing diagnosis is that a patient without obvious severe symptoms is often last in line for diagnosis, sometimes with dangerous results. The current system and method automate the identification of a patient's more subtle risk factors, in order to expedite the diagnosis of patients who have high (but not immediately apparent) risk.

In one such clinical embodiment, the health information system of the current disclosure could include a feature that captures data related to a patient. That data could be related to the patient's initial signs, symptoms, presenting diagnosis, gender, age, physical fitness level, race, weight, height, alcohol or drug use, family history, allergies, current medications, etc. The health information system could then trend that data with regard to the ultimate outcome of each case. This knowledge of the statistical correlation between certain keywords in patient data and an unfavorable clinical outcome could then be utilized by the health information system to encourage more immediate diagnosis and/or treatment for high-risk patients. This could be done even where not explicitly realized or requested by the referring provider.

The system described above could be implemented as follows. In a clinical setting, it is common practice to collect patient defining attributes (such as gender, age, physical fitness level, race, weight, height, alcohol or drug use, family history, allergies, current medications, etc.) along with signs, symptoms and a presenting diagnosis from a referring physician when a patient is referred for an examination. This information is typically captured in a healthcare information system. This data would then be available for future data mining. The outcome of each case is also typically captured in the healthcare information system in the form of an interpreting diagnosis and/or a diagnostic report. This data would also be available for future data mining.

Analysis of a correlation between certain defining attributes, signs, symptoms, and/or presenting diagnosis and an unfavorable outcome could lead to the identification of certain keywords that would indicate a high-risk patient. Subsequently, the presence of these keywords on future cases could trigger warning to caretakers that the current patient should be processed with additional care and/or urgency. In order to facilitate prioritization of the case in question, the healthcare information system could even go so far as to automatically flag the case as a “stat” exam, thereby allowing it to be recognized and prioritized by existing workflows.

In another embodiment, the current system and method analyzes trends to determine a course of action that has presented positive results in the past. In a clinical environment, the systems and methods of this embodiment could analyze historical patient diagnosis and treatment information to determine which treatment is likely to deliver a favorable outcome based on trend analysis. The system and/or method would provide guidance to a user when deciding upon a treatment for the patient by displaying treatments used for other patients with similar variables that achieved a degree of success.

This embodiment could be implemented similarly to the one discussed above. As discussed above the patient defining attributes, signs, symptoms and a presenting diagnosis would be obtained when the patient is referred for an examination. The information would be captured in a healthcare information system and would be available for future data mining as discussed above. The outcome of each case would also be captured in the healthcare information system and be available for future data mining. In addition the treatment would also be collected in the healthcare information system for future data mining.

Analysis of a correlation between certain defining attributes, signs, symptoms, and/or presenting diagnosis, treatment used and a favorable outcome could lead to the identification of treatments resulting in a high degree of success for similarly situated patients. This would allow the caretaker to input the defining attributes, signs, symptoms, presenting diagnosis, etc. for the current case. Using the analysis, the system could then provide the caretaker with a treatment or list of treatments that have statistically resulted in a high degree of success for a similarly situated patient.

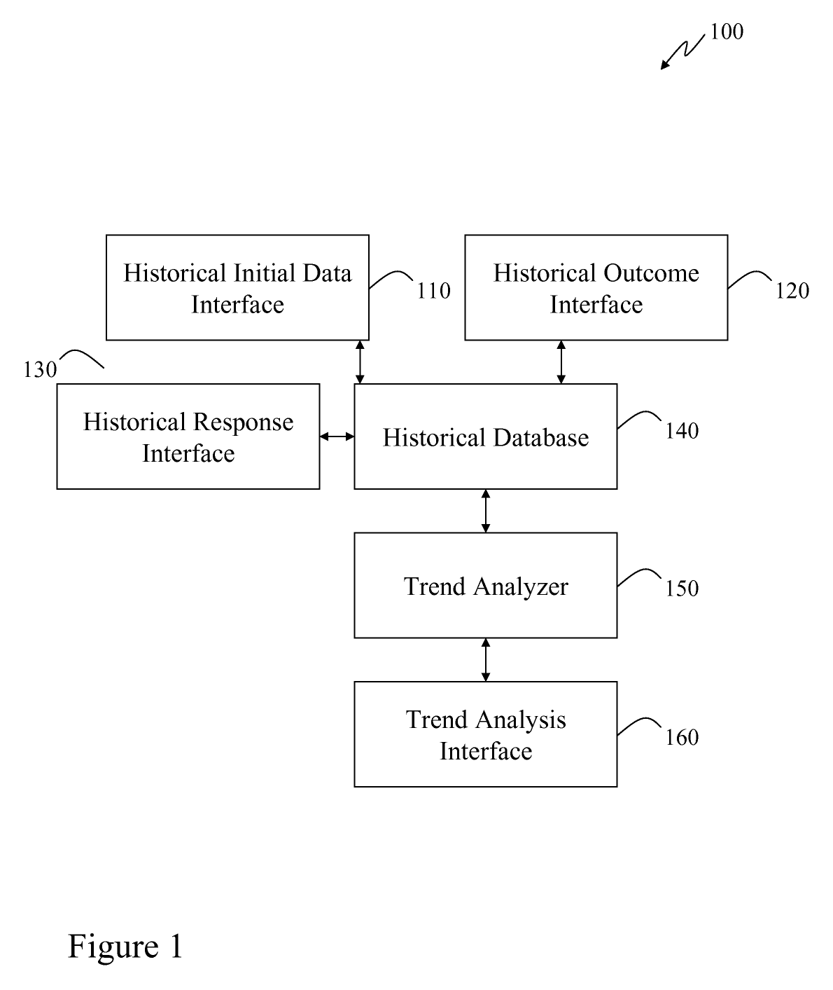

FIG. 1 illustrates a clinical system (100) for determining a course of action in a real-time patient case based on analysis of trend data in historical patient cases according to an embodiment of the present technology. In one embodiment, the present system (100) comprises an historical initial data interface (110), an historical outcome interface (120), an historical response interface (130), an historical database (140), a trend analyzer (150), and a trend analysis interface (160).

The historical initial data interface (110) is in communication with the historical database (130) and vice versa. The historical outcome interface (120) is in communication with the historical database (140) and vice versa. The historical response interface (130) is in communication with the historical database (140) and vice versa. The historical initial data interface (110), historical outcome interface (120) and historical response interface (130) can also be in communication with each other. The historical database (140) is in communication with the trend analyzer (150) and vice versa. The trend analyzer (150) is in communication with the trend analysis interface (160) and vice versa.

Various components of the system can be separate or combined into a single component. For example, the historical initial data interface (110), the historical outcome interface (120), the historical response interface (130) and the trend analysis interface (160) can be combined together in a combination of two, three or four interfaces. The interfaces could also be separate. Similarly other components of the system could be combined or separate.

The components of the system (100) may be implemented alone or in combination with hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. The system may be integrated in various forms and/or may be provided as software and/or other functionality on a computing device, such as a computer. Certain embodiments may omit one or more of the components of the system (100).

The current system (100) is comprised of an historical initial data interface (110). The historical initial data interface (110) allows for input of historical initial data regarding more than one historical case. The historical initial data interface could be presented to the user using a specialized website, a desktop, laptop or handheld computing device that is connected over a network to the information system, or a home computer using specialized software, for example. The user could input historical initial data using an input device. Examples of input devices include, but are not limited to, keyboards, touchscreens, joysticks, mice, touchpads, and microphones.

The historical initial data interface (110) could also obtain additional historical initial data by interfacing with other information systems. In a healthcare information system, possible examples of historical initial data from interfaces with other healthcare information systems include prior enterprise care records, lab tests, medication lists, and care plans.

In a clinical system, the initial data could include a patient's signs and symptoms. The initial data could also include the presenting diagnosis from the referring physician. The initial data could also include defining attributes such as gender, age, physical fitness level, race, weight, height, alcohol or drug use, family history, allergies, current medications, etc.

The current system (100) is further comprised of an historical outcome interface (120). The historical outcome interface (120) allows for association of an historical outcome with each of the historical cases. The historical outcome interface (120) could obtain historical outcomes from the user in a similar manner to the historical initial data interface (110) discussed above. For example, it could be presented using a specialized website, a desktop, laptop or handheld computing device that is connected over a network to the information system, or a home computer using specialized software, for example. The user could input historical outcomes using an input device. Examples of input devices include, but are not limited to, keyboards, touchscreens, joysticks, mice, touchpads, and microphones. As discussed above with regards to the historical initial data interface (110), the historical outcome interface (120) could also obtain additional historical outcomes by interfacing with other information systems.

In a clinical system, the historical outcome could range between death and full recovery. Various systems could be used to describe the outcome. The caretaker could use prose to verbally describe the historical outcome. The caretaker could use quantitative test results to indicate the historical outcome. The caretaker could be posed with a series of questions regarding the patient's physical state after treatment. In another embodiment, the historical outcome could be assigned a degree of success by the caretaker. This degree of success could be qualitative, such as “good, satisfactory, fair, poor.” The degree of success could also be based on a quantitative sliding scale with a certain number representing full recovery and another representing death or no improvement.

The historical response interface (130) allows for association of an historical response with each of said historical cases. The historical response interface (130) could obtain historical response data from the user in a similar manner to the historical initial data interface (110) discussed above. For example, it could be presented using a specialized website, a desktop, laptop or handheld computing device that is connected over a network to the information system, or a home computer using specialized software, for example. The user could input historical responses using an input device. Examples of input devices include, but are not limited to, keyboards, touchscreens, joysticks, mice, touchpads, and microphones. As discussed above with regards to the historical initial data interface (110), the historical response interface (130) could also obtain additional historical responses by interfacing with other information systems.

In a clinical setting, the historical response would be the treatment used to treat the patient in each of the historical cases, such as prescribed medications, chemotherapy, radiation, physical therapy, surgery, etc. For example where a certain cancer patient was treated with chemotherapy the caretaker could input chemotherapy into the historical response interface.

The historical initial data interface (110), the historical outcome interface (120) and the historical response interface (130) are in communication with a historical database (140). The historical database (140) stores the initial data, historical responses and historical outcomes of each of the historical cases.

The historical database (140) is in communication with a trend analyzer (150). The trend analyzer (150) analyzes the data stored in the historical database (140). Specifically, the trend analyzer (150) analyzes the historical initial data, historical outcomes and historical responses. The trend analyzer (150) identifies trends between the historical responses, historical initial data and historical outcomes.

The trend analyzer (150) could identify a trend of historical negative outcomes from historical cases having similar historical initial data. This would be advantageous because it could alert the user of initial data that could indicate a situation that has produced a trend of negative outcomes in the past. For example, individuals of a certain gender, age and weight could exhibit a trend towards certain health problems. Similarly, individuals complaining of a certain set of signs and/or symptoms could exhibit a trend toward a certain health problem. The current system would help the caretaker to identify these health problems and prioritize diagnosis of these patients.

Conversely, the trend analyzer (150) could identify a trend of historical positive outcomes from historical cases having similar historical initial data and using a certain historical response. This would be advantageous because it could direct the user to a response that has produced a trend of positive outcomes in the past. As a clinical example, individuals of a certain gender, age and weight show a trend of positive results to a certain type of treatment. Similarly, individuals having a certain set of signs and/or symptoms could show a trend of positive results to a certain type of treatment. The current system would help the caretaker to identify a treatments showing a trend of positive results so that he or she could use this treatments on the current patient.

The trend analyzer (150) is in communication with a trend analysis interface (160). The trend analysis interface (160) allows for input of initial data regarding a real-time case. The initial data for the real-time case would be similar to that obtained by the historical initial data interface (110) above. However, it would be related to a presently occurring or “real-time” case. In a clinical system, the initial data could include a patient's signs and symptoms. The initial data could also include the presenting diagnosis from the referring physician. The initial data could also include defining attributes such as gender, age, physical fitness level, race, weight, height, alcohol or drug use, family history, allergies, current medications, etc.

The trend analysis interface (160) could obtain data from the user in a similar manner to the historical initial data interface (110) discussed above. For example, it could be presented using a specialized website, a desktop, laptop or handheld computing device that is connected over a network to the information system, or a home computer using specialized software, for example. The user could input initial data using an input device. Examples of input devices include, but are not limited to, keyboards, touchscreens, joysticks, mice, touchpads, and microphones.

As discussed above with regards to the historical initial data interface (110), the trend analysis interface (160) could also obtain initial data regarding a real-time case by interfacing with other information systems. In a healthcare information system, possible examples of data from interfaces with other healthcare information systems include signs, symptoms, presenting diagnosis, gender, age, physical fitness level, race, weight, height, alcohol or drug use, family history, allergies, current medications, etc.

The trend analysis interface (160) also displays output regarding a recommended course of action in the real-time case based on the identified trends from historical cases having similar historical initial data to the initial data in the real-time case. The trend analysis interface (160) gets this information from the trend analyzer (150). The trend analysis interface (160) would then compare the initial data for the real-time case with the trends identified by the trend analyzer (160).

The current system would identify trends of both negative and positive outcomes. Identifying initial data that create a trend of negative outcomes allows the user to avoid a problem. In a clinical setting, identifying trends of negative outcomes for patients showing certain initial data allows the caretaker to prioritize diagnosis of those patients. Identifying initial data and responses that create a trend of positive outcomes allows the user to determine a course of action that is likely to create a positive outcome. In a clinical setting, identifying trends of positive outcomes for patients with certain initial data given certain treatment allows the caretaker to use the treatment that creates a likely positive outcome.

As discussed above, the trend analyzer (160) can identify a trend of historical negative outcomes in historical cases where similar initial data exists. If the real-time case has similar initial data to cases showing a trend of negative outcomes, the trend analysis interface (160) could display an output recommending prioritization of the real-time case.

As discussed above, the trend analyzer (160) can conversely identify a trend of historical positive outcomes in historical cases where similar initial data exists and a certain response is used. If the real-time case has similar initial data to cases showing a trend of positive outcomes with a certain response, the trend analysis interface (160) could display output recommending that certain response that showed a trend of positive outcomes in similar cases.

After the real-time case discussed above has been concluded, it can be added to the historical database. This updates the historical database and increases the pool from which to derive trend data. This could be done manually by the caretaker or automatically.

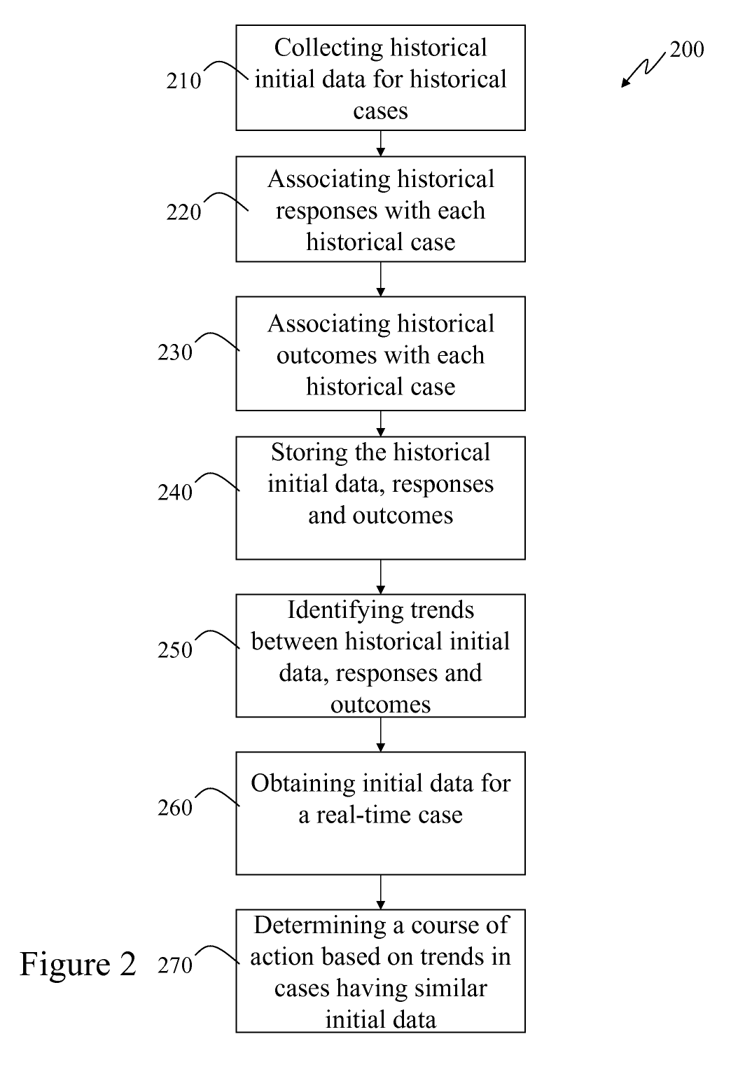

FIG. 2 illustrates a clinical method (200) of determining a course of action in a real-time patient case based on analysis of trend data in historical patient cases according to an embodiment of the present technology. The method (200) involves obtaining historical initial data for more than one historical case (210); associating an historical response with each of the historical cases (220); associating an historical outcome with each of the historical cases (230); storing the historical initial data and the associated historical responses and outcomes for each of the historical cases (240); identifying trends between the historical initial data and the associated historical responses and outcomes in the historical cases (250); obtaining initial data for the real-time case (260); and determining a course of action in the real-time case based on the identified trends from historical cases having similar historical initial data to the initial data regarding the real-time case (270). These method steps can be performed sequentially or in another order.

In the first step, historical initial data for more than one historical case is obtained (210). This can be done using an historical initial data interface, such as (110) discussed above. The historical initial data could be obtained from a user using a specialized website, a desktop, laptop or handheld computing device that is connected over a network to the information system, or a home computer using specialized software, for example. The user could input historical initial data using an input device. Examples of input devices include, but are not limited to, keyboards, touchscreens, joysticks, mice, touchpads, and microphones.

The additional historical initial data could also be obtained by interfacing with other information systems. In a healthcare information system, possible examples of historical initial data from interfaces with other healthcare information systems include signs, symptoms, presenting diagnosis, gender, age, physical fitness level, race, weight, height, alcohol or drug use, family history, allergies, current medications, etc.

In a clinical system, the historical initial data could include a patient's signs and symptoms. The historical initial data could also include the presenting diagnosis from the referring physician. The historical initial data could also include defining attributes such as gender, age, physical fitness level, race, weight, height, alcohol or drug use, family history, allergies, current medications, etc.

In the next step, an historical response is associated with each of said historical cases (220). This can be done using an historical response interface, such as the (130) discussed above. The historical responses could be obtained from the user in a similar manner to the historical initial data in step (210) discussed above. For example, it could be presented using a specialized website, a desktop, laptop or handheld computing device that is connected over a network to the information system, or a home computer using specialized software, for example. The user could input historical responses using an input device. Examples of input devices include, but are not limited to, keyboards, touchscreens, joysticks, mice, touchpads, and microphones. Additional historical response data could also be obtained by interfacing with other information systems.

In a clinical setting, the historical response would be the treatment used to treat the patient in each of the historical cases, such as prescribed medications, chemotherapy, radiation, physical therapy, surgery, etc. For example where a certain cancer patient was treated with chemotherapy the caretaker could input chemotherapy into the historical response interface.

In the next step, an historical outcome is associated with each of the historical cases (230). This can be done using an historical outcome interface, such as (120) discussed above. The historical outcomes could be obtained from the user in a similar manner to the historical initial data in step (210) discussed above. For example, it could be presented using a specialized website, a desktop, laptop or handheld computing device that is connected over a network to the information system, or a home computer using specialized software, for example. The user could input historical outcomes using an input device. Examples of input devices include, but are not limited to, keyboards, touchscreens, joysticks, mice, touchpads, and microphones. Additional historical outcomes could be obtained by interfacing with other information systems.

In a clinical system, the historical outcome could range between death and full recovery. Various systems could be used to describe the historical outcome. The caretaker could use prose to verbally describe the historical outcome. The caretaker could use quantitative test results to indicate the historical outcome. The caretaker could be posed with a series of questions regarding the patient's physical state after treatment. In another embodiment, the historical outcome could be assigned a degree of success by the caretaker. This degree of success could be qualitative, such as “good, satisfactory, fair, poor.” The degree of success could also be based on a quantitative sliding scale with a certain number representing full recovery and another representing death or no improvement.

In the next step, the historical initial data and the associated historical responses and outcomes for each of the historical cases is stored (240). This can be done using an historical database, such as (140) discussed above. The historical initial data and the historical outcomes of each of the historical cases are stored. The associated historical responses will similarly be stored in the database. The data from the historical cases is stored for later trend analysis.

In the next step, trends between the initial data and the associated responses and outcomes in the historical cases are identified (250). This can be done using a trend analyzer, such as (145) discussed above. Trends between responses, initial data and outcomes are identified.

Trends of historical negative outcomes from historical cases having similar historical initial data are identified. This is advantageous because it could alert the user of initial data that could indicate a situation that has produced a trend of negative outcomes in the past. For example, individuals of a certain gender, age and weight could exhibit a trend towards certain health problems. Similarly, individuals complaining of a certain set of signs and/or symptoms could exhibit a trend toward a certain health problem. The current system would help the caretaker to identify these health problems.

Conversely, trends of historical positive outcomes from historical cases having similar historical initial data and using a certain historical response are also identified. This is advantageous because it could direct the user to a response that has produced a trend of positive outcomes in the past. For example, individuals of a certain gender, age and weight could show a trend of positive results to a certain type of treatment. Similarly, individuals having a certain set of signs and/or symptoms could show a trend of positive results to a certain type of treatment. The current system would help the caretaker to identify a treatments showing a trend of positive results based on initial data.

In the next step, initial data for a real-time case is obtained (260). This can be done using a trend analysis interface, such as (160) discussed above. The initial data for the real-time case would be similar to the historical initial data obtained in step (210) above. However, it would be related to a presently occurring or “real-time” case. In a clinical system, the initial data could include a patient's signs and symptoms. The initial data could also include the presenting diagnosis from the referring physician. The initial data could also include defining attributes such as gender, age, physical fitness level, race, weight, height, alcohol or drug use, family history, allergies, current medications, etc.

The real-time initial data could be obtained from the user in a similar manner to the historical initial data obtained in step (210) above. For example, it could be presented using a specialized website, a desktop, laptop or handheld computing device that is connected over a network to the information system, or a home computer using specialized software, for example. The user could input real-time initial data using an input device. Examples of input devices include, but are not limited to, keyboards, touchscreens, joysticks, mice, touchpads, and microphones.

Real-time initial data could also be obtained by interfacing with other information systems. In a healthcare information system, possible examples of data from interfaces with other healthcare information systems include signs, symptoms, presenting diagnosis, gender, age, physical fitness level, race, weight, height, alcohol or drug use, family history, allergies, current medications, etc.

In the next step, a course of action in the real-time case is determined based on the identified trends from historical cases having similar historical initial data to the initial data in the real-time case (270). This can also be done using a trend analysis interface, such as (160) discussed above. Trends in both negative and positive outcomes were identified in step (250) above. Identifying historical initial data that create a trend of negative outcomes allows the user to avoid a problem in a real-time case with similar initial data. In a clinical setting, identifying trends of historical negative outcomes for patients showing certain historical initial data allows the caretaker to prioritize diagnosis of real-time patients showing similar initial data. Identifying historical initial data and historical responses that create a trend of historical positive outcomes allows the user to determine a course of action in a real-time case with similar initial data that is likely to create a positive outcome. In a clinical setting, identifying trends of historical positive outcomes for patients with certain historical initial data given certain treatment allows the caretaker to use that treatment in a real-time case with similar initial data. Thus, increasing the likelihood of a positive outcome.

If the real-time case has similar initial data to cases showing a trend of negative outcomes, the current method would determine a course of action prioritizing the real-time case. If the real-time case has similar initial data to cases showing a trend of positive outcomes with a certain response, the current method would determine a course of action using the same treatment for the real-time case.

After the real-time case discussed above has been concluded, it can be used as one of the historical cases. This updates the pool from which to derive trend data. This could be done manually by the caretaker or automatically.

One or more of the steps of the methods (200) may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments may be implemented in one or more of the systems described above. For example, certain embodiments of the method (200) may be implemented using one or more local EMR (electronic medical record) systems, a database or other data storage storing electronic data, and one or more user interfaces facilitating capturing, integrating and/or analyzing information inputted by the patient.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

In one example, a healthcare information system could include a feature that allows the caretaker to enter historical initial data related to patients' initial signs, symptoms and/or presenting diagnosis. This could be done using an historical initial data interface, such as (110) described above. The healthcare information system could also allow the caretaker to enter historical outcomes for these patients. This could be done using an historical outcome interface, such as (120) described above. The healthcare information system could similarly allow the user to enter historical responses (or treatments) used on these patients to obtain the historical outcomes. This could be done using an historical response interface, such as (130) described above. The historical initial data, responses and outcomes would be saved in the healthcare information system. This could be done using an historical database, such as (140) described above. The healthcare information system would analyze the data to find trends between the historical initial data, responses and outcomes. The healthcare information system could find trends of negative outcomes for cases with similar historical initial data. The healthcare information system could also find trends of positive outcomes for cases with similar historical data treated with a similar response. This could be done using a trend analyzer, such as (150) described above.

When a real-time patient enters the healthcare clinic, the clinician could enter his or her initial data into the healthcare information system. This could be done using a trend analysis interface, such as (160) described above. The healthcare information system could use the historical trends to create an output for the caregiver. This could also be done using a trend analysis interface, such as (160) described above. If the patient had similar initial data to historical initial data matching a trend of negative outcomes, the healthcare information system could give an indication that the patient should receive priority diagnosis. The caregiver could then prioritize the patient's diagnosis possibly resulting in a better outcome.

The healthcare information system could also use the patient's initial data to output a suggested course of treatment. This could also be done using a trend analysis interface, such as (160) described above. The healthcare information system would compare the patient's initial data with historical initial data showing a trend in positive outcomes. The healthcare information system could then find trends in historical responses used to obtain such outcomes. The healthcare information system could output the recommended treatment based on the trend of positive outcomes obtained for previous patients with similar initial data using that treatment.

Thus, certain embodiments provide the technical effect of determining a course of action in a real-time patient case based on analysis of trend data in historical patient cases. One particular embodiment provides the technical effect of recommending treatment and/or priority of diagnosis in a real-time case based on analysis of outcome trends in historical data.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any clinical software feedback and dynamic scheduling/planning system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A clinical system for determining a course of action in a real-time patient case based on analysis of trend data in historical patient cases comprising:
an historical initial data interface wherein said historical initial data interface allows for input of historical initial data regarding more than one historical case;
an historical outcome interface wherein said historical outcome interface allows for association of an historical outcome with each of said historical cases;
an historical response interface wherein said historical response interface allows for association of an historical response with each of said historical cases;
an historical database wherein said historical database stores said historical initial data and said associated historical responses and outcomes of each of said historical cases;
a trend analyzer wherein said trend analyzer identifies trends between said historical initial data and said historical responses and outcomes; and
a trend analysis interface wherein said trend analysis interface allows for input of initial data regarding said real-time case and wherein said trend analysis interface displays output regarding a recommended course of action in said real-time case based on said identified trends from historical cases having similar historical initial data to said initial data in said real-time case.

2. The system of claim 1 wherein said trend analysis interface displays output recommending prioritization of said real-time case where said identified trends show a trend of negative outcomes from said historical cases having similar historical initial data to said initial data in said real-time case.

3. The system of claim 1 wherein said trend analysis interface displays output recommending a response where said identified trends show a trend of positive outcomes from said historical cases having similar historical initial data to said initial data in said real-time case when using said historical response.

4. The system of claim 1 wherein said initial data includes signs and symptoms.

5. The systems of claim 1 wherein said initial data includes presenting diagnosis.

6. The system of claim 1 wherein said initial data includes defining attributes.

7. The system of claim 6 wherein said defining attributes include at least one of gender, age, physical fitness level, race, weight, height, alcohol use, drug use, family history, allergies, and current medications.

8. The system of claim 1 wherein said real-time case is added to said historical database upon completion.

9. A clinical method of determining a course of action in a real-time patient case based on analysis of trend data in historical patient cases comprising:
obtaining historical initial data for more than one historical case;
associating an historical response with each of said historical cases;
associating an historical outcome with each of said historical cases;
storing said historical initial data and said associated historical responses and outcomes for each of said historical cases;
identifying trends between said historical initial data and said associated historical responses and outcomes in said historical cases;
obtaining initial data for said real-time case; and
determining a course of action in said real-time case based on said identified trends from historical cases having similar historical initial data to said initial data in said real-time case.

10. The method of claim 9 wherein the steps are performed sequentially.

11. The method of claim 9 wherein said course of action is recommending prioritization of said real-time case where said identified trends show a trend of negative outcomes from said historical cases having similar historical initial data to said initial data regarding said real-time case.

12. The method of claim 9 wherein said course of action is determined to be a response based on said identified trends showing a trend of positive outcomes from said historical cases having similar historical initial data to said initial data in said real-time case when using said response.

13. The method of claim 9 wherein said initial data includes signs and symptoms.

14. The method of claim 9 wherein said initial data includes presenting diagnosis.

15. The method of claim 9 wherein said initial data includes defining attributes.

16. The method of claim 9 wherein said defining attributes include at least one of gender, age, physical fitness level, race, weight, height, alcohol use, drug use, family history, allergies, and current medications.

17. The method of claim 9 wherein said real-time case is added to said historical database upon completion.

18. A computer-readable medium having a set of instructions for execution by a computer, the set of instruction comprising:
an historical initial data collection routine configured to collect historical initial data for more than one historical case;
an historical response association routine configured to associate an historical response with each of said historical cases;
an historical outcome association routine configured to associate an historical outcome with each of said historical cases;
a storage routine configured to store said historical initial data and said associated historical responses and outcomes for each of said historical cases;
a trend identification routine configured to identify trends between said historical initial data and said associated historical responses and outcomes in said historical cases;
a real-time data collection routine configured to collect initial data for a real-time case; and
a display routine configured to display a determined course of action for said real-time case based on said identified trends from historical cases having similar historical initial data to said initial data in said real-time case.

19. The computer-readable medium of claim 9 wherein said course of action is recommending prioritization of said real-time case where said identified trends show a trend of negative outcomes from said historical cases having similar historical initial data to said initial data regarding said real-time case.

20. The computer-readable medium of claim 9 wherein said course of action is determined to be a response based on said identified trends showing a trend of positive outcomes from said historical cases having similar historical initial data to said initial data in said real-time case when using said response.
